(19) United States
(12) Patent Application Publication
(10) Pub. No.: US 2007/0230950 A1
(43) Pub. Date: Oct. 4, 2007

(54) IMAGE CAPTURE DEVICE

(75) Inventor: Yu-Cheng Huang, Jhudong Township (TW)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: ALTEK CORPORATION, Hsinchu (TW)

(21) Appl. No.: 11/458,198

(22) Filed: Jul. 18, 2006

(30) Foreign Application Priority Data
Mar. 29, 2006 (TW) 095111062

(51) Int. Cl. G03B 17/02

(52) U.S. Cl. 396/541

(57) ABSTRACT

An image capture device is used for capturing an image and storing it as digital data. It comprises a signal processing module and an optical module. The optical module detachably disposed n the signal process module and used for capturing the image and transferring to an image data. The signal processing module receives and processes the image data and then stores it as the digital data. Therefore, users can attach different optical module with different shooting elements on the signal processing module according to different shooting requirements of environment to obtain best image quality.

### CROSS-REFERENCE TO RELATED APPLICATIONS

This non-provisional application claims priority under 35 U.S.C. § 119(a) on Patent Application No(s). 095111062 filed in Taiwan, R.O.C. on Mar. 29, 2006, the entire contents of which are hereby incorporated by reference.

### BACKGROUND OF THE INVENTION

1. Field of Invention

The present invention relates to an image capture device, and more particularly, to an image capture device capable of displacing a signal processing module or an optical module according to the shooting requirement.

2. Related Art

With the great development of current technology, digital products in the market are continually being upgraded and prices lowered. Consume image capture devices such as cell phones with image shooting function, PDAs, and digital cameras are gradually becoming popular, and in particular, the “shoot and see” convenient function of the digital camera has completely substituted the conventional camera using film, and has become a convenient tool used by the masses in daily life and work to record things.

In the consume digital electronic products with the function of image capturing such as cell phones and digital cameras currently found in the market, the camera lens and sensing element thereof are designed integrally with the body of the image capture device. Therefore, during the process of manufacturing and assembling the image capture device, the optical property specifications of the image capturing have been specified, such as lens type, diaphragm form, pixels of the sensing element, and focusing system. However, since the developing speed of the optical industry is quite fast, more novel and more advanced digital image capture device are launched continually, such that after the user has purchased a newly-launched image capture device, products having improved performance come into market after a period of time. For users, a considerable sum of money must be spent in order to pursue the consume image capture device of best function and best performance.

When the user is shooting with the image capture device, it is required to adjust to the device to the most appropriate shooting mode in accordance with different sceneries such as distant view, near view, static or dynamic shooting, or intensity of light, so as to obtain the best shooting effect. However, the optical property specification of the consume image capture device according to the conventional art has been limited when being manufactured and assembled and no alteration can be made to the specification, so that when shooting, the user needs to take along various image capture devices of different specifications to obtain the best image quality. For the user, it is quite heavy and inconvenient to take along multiple image capture devices.

In addition, the consume image capture device of the conventional art cannot change the pixel specification of the sensing element, resulting in the deficiency of pixels used by the image capture device in shooting, or a waste of resource caused by shooting in excessive pixels, so that the image capture device cannot achieve the best usage efficiency.

The consume image capture device of the conventional art is an all-in-one design, so the optical specification of the image capture device is limited when being manufactured, and the required specification cannot be replaced freely. If different camera lenses, pixels, diaphragm or focusing systems etc. are needed to be replaced, it is necessary to purchase consume image capture devices of different specifications to satisfy multiple shooting modes. Taking T-series consume digital camera launched by SONY as an example, the specification of two digital cameras DSC-T9 and DSC-T7 often found in the market are quite similar, only except that there is slight differences in pixel (6183 k pixels for T9 and 5255 k pixels for T7) and shutter speed (⅛- 1/2000s for T9 and ¼- 1/1000s for T7), which results in having to manufacture two different types of digital camera. For the user, unless he/she can afford both, he/she must choose only one to buy. The kind of multiple designs of the same type but having slight differences in specification is always the marketing strategy of the manufacturer and will not benefit the consumers actually. Moreover, professional digital camera can change the lens component according to the different shooting requirement of the users. However, the replacement of the lens component is just done for the elements such as lens type, focal length and diaphragm, however, the pixel specification deciding the image quality effect cannot be changed.

When the image capture device is damaged, the whole image capture device needs to be sent for being repaired, resulting in the trouble that no image capture device is available for the user during the repair and even the whole image capture device have to be changed. Thus the user has to spend much more money to repurchase new image capture device, and the usage efficiency of the image capture devices is not satisfying, resulting in a waste of money and resources. Moreover, since the specification of the consume image capture device of the conventional art is fixed and cannot be changed, it causes that the user is cannot increase the pixels of the image capture device, so that after being used for a period of time, the specification of the image capturing will not be in accordance with use requirements and must be replaced.

### SUMMARY OF THE INVENTION

Since the design of the image capture device according to the conventional art is an all-in-one design of a lens module and a body of the image capture device, the problem that the requirement of shooting quality cannot be changed results.

In view of the above problem, the present invention provides an image capture device for improving the limitation or disadvantage in the prior art that the lens module and the body of the image capture device cannot be replaced individually such that cannot satisfy the requirements of the user for shooting quality.

The present invention is an image capture device, which comprises a signal processing module and an optical module. The optical module is detachable disposed on the signal processing module. The optical captures an image and transfers to an image data. The signal processing module receives and processes the image data and stores as digital data.

The optical module and the signal processing module further have respectively a second connecting element and a first connecting element. The first and second connecting element is detachably electrically connected to each other for the signal processing module to receive the image data.

The signal processing module comprises a shutter button. When the shutter button is pressed, the signal processing module sends a capture command to the optical module to start capturing the image.

The image capture device described above can provide more flexibility to users. Users can have more than one optical module to detach on the signal processing module to satisfy with different shooting requirements.

Besides, the invention also discloses an image capture device comprising a signal processing module, a first optical module detachable disposed on the signal processing module, a second optical module built in the signal processing module and a switching module. The first optical module captures the image and transfers to a first image data and the second optical module captures the image and transfers to a second image data. The switching module selectively switches the first image data or the second image data to the signal processing module to be received, processed and stored as the digital data. Therefore, users can have the second optical module different from the second optical module to have two different shooting parameters to fit different shooting environment.

The functionality of the present invention lies in replacing the signal processing module or the optical module according to the shooting requirement of the user, so as to satisfy different requirements of the users for the image quality in shooting. By replacing the optical module, the lens type, diaphragm and focusing system of different specification can be changed, and the pixel specification of the sensing element can be changed, without replacing the whole image capture device but only one of the components to realize an image capture device with multiple specification, so as to reduce the cost for users to purchase the image capture device.

The features and advantages of the present invention described above will become more apparent from the detailed description of the specific embodiment set forth below when taken in conjunction with the drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1A is an exploded schematic view according to one embodiment of the present invention;

FIG. 1B is an assembled schematic front view according to one embodiment of the present invention;

FIG. 1C is an assembled schematic back view according to one embodiment of the present invention;

FIG. 2A is an exploded schematic view according to another embodiment of the present invention; and

FIG. 2B is an assembled schematic view according to another embodiment of the present invention.

### DETAILED DESCRIPTION OF THE INVENTION

The image capture device disclosed according to the present invention can be the consume electrical products with the function of image capturing such as cell phones, cameras, and PDAs, while the digital camera is used as the most preferable embodiment of the present invention in the detailed description of the present invention hereinafter. However, the accompanied drawings are provided just for reference and illustration and are not intended to limit the present invention.

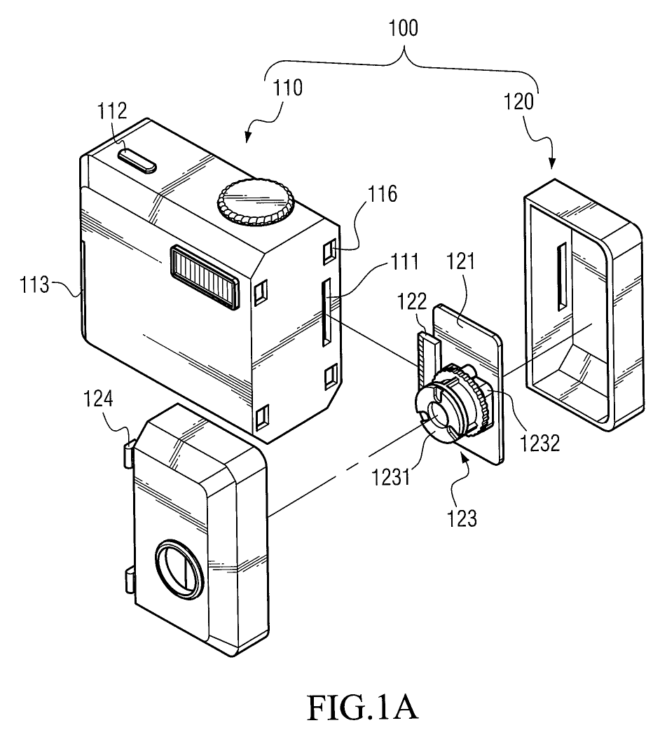

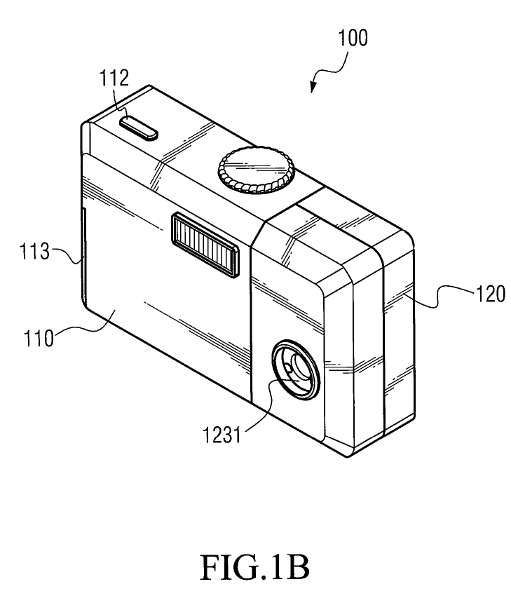

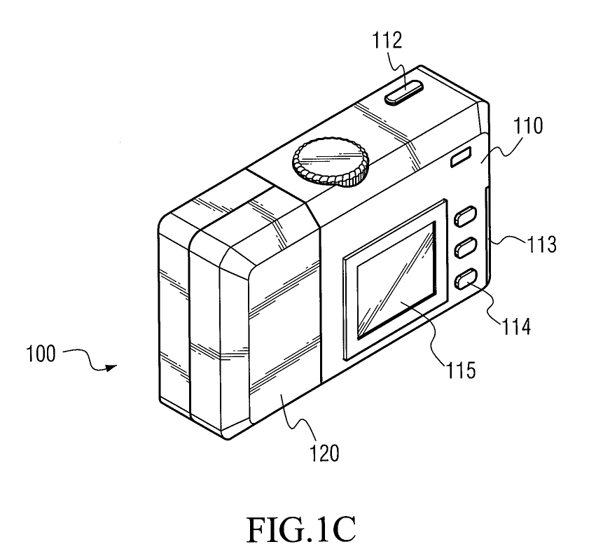

Please refer to FIG. 1A, the image capture device 100 is used for capturing an image and storing it as digital data and comprises a signal processing module 110 and an optical module 120. The optical module 120 is detachably disposed on the signal processing module 110 and used for capturing an image and transferring to an image data. The signal processing module 110 receives and processes the image data and then stores it as digital data. Hence, users can attach different optical module on the signal processing module to satisfy with different shooting requirements.

The signal processing module 110 comprises a first circuit board (not shown) and a first connecting element 111, while the optical module 120 comprises a second circuit board 121, a second connecting element 122 and an image capture unit 123. The first circuit board of the signal processing module 110 and the second circuit board 121 of the optical module 120 are electrically connected by coupling the first connecting element 111 and the second element 122 with each other. The image signal captured by the optical module 120 is transmitted to the signal processing module 110 for being processed through the coupling of the connecting elements 111, 122.

As shown in FIG. 1A, the first connecting element 111 and the second connecting element 122 are respectively disposed on the two opposite sides of the signal processing module 110 and the optical module 120, so as to ensure the connection of the optical module 120 and the signal processing module 110 being at a forward position, thus preventing the user from confusing the direction of image capturing. Also, the image capture unit 123 of the optical module 120 has a lens 1231 and a sensing element 1232. The user can replace the optical module 120 at anytime to change different types of the lens 1231, such as standard lens, wide angle lens, super wide angle lens and telephoto lens according to the required specification of the user, and the diaphragm on the lens 1321 can also be adjusted with the replacement of the lens 1231. The pixel specification of the sensing element 1232 is changed according to the image quality required by the user to shoot at an appropriate pixel specification, so as to avoid deficiency of pixels used in shooting or a waste of resources caused by shooting in excessive pixels. The focusing system of the optical module 120 can also change the focusing mode of the image capture device 100 according to different optical modules 120 together with the signal processing module 110. Moreover, the sensing element 1232 of the image capture unit 123 is either the image sensor of Charge Coupled Device (CCD) or the image sensor of Complementary Metal Oxide Semiconductor (CMOS).

As shown in FIGS. 1B and 1C, the signal processing module 110 further comprises a shutter button 112, a cell 113, an interface button 114 and a display screen 115. The shutter button 112 is used to send a capture command to the optical module 120 to start capturing the image. The cell 113 is electrically connected to the first circuit board for providing a power supply. The interface button 114 is electrically connected to the first circuit board for providing an operating interface for users to set the shooting mode of the image capture device 110. The display screen 115 is electrically connected to the first circuit board for displaying the image state focused by the optical module 120.

Referring to FIG. 1A, the image capture device 110 disclosed in the present invention further comprises a snap structure. The snap structure comprises at least one hook 124 disposed at a side of the optical module 120, and at least one slot 116 disposed at a side of the signal processing module 110 opposite to the hook 124, such that the signal processing module 110 and the optical module 120 are jointed with each other and not easy to release. It should be noted that the combination manner of the signal processing module 110 and the optical module 120 can be any structure or mechanical design of being jointed at an angle and is not limited to that of the present embodiment.

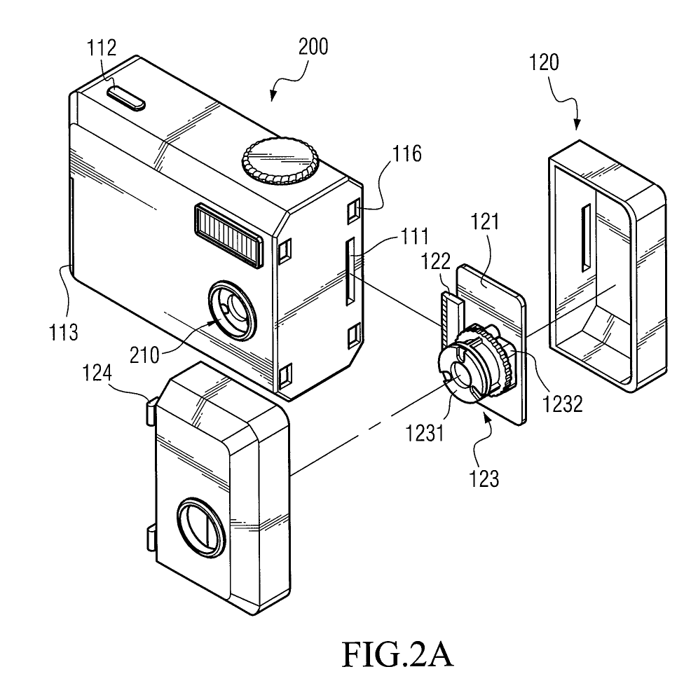

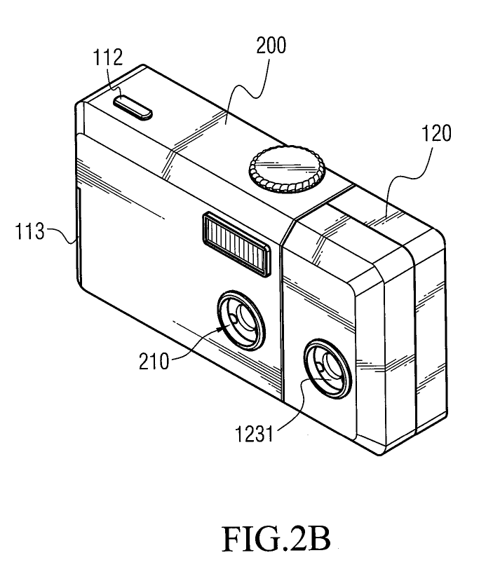

FIGS. 2A and 2B are schematic views of another embodiment of the present invention. The image capture device in this embodiment comprises a signal processing module 200, a first optical module 120 detachable disposed on the signal processing module 200, a second optical module 210 built in the signal processing module 200, and a switching module (not shown in FIGs). The first optical module 120 captures the image and transfers to a first image data and the second optical module 210 captures the image and transfers to a second image data. The switching module selectively switches the first image data or the second image data to the signal processing module 200 to be received, processed and stored as the digital data. The first optical module 120 and the second optical module 210 are equipped with different shooting elements, for example, different lenses, diaphragms, focusing systems and pixel specifications. Therefore, users can attach different the first optical module 120 on the signal module 200 according to the shooting environment.

In the market of the consume digital cameras, the V570 dual lens camera produced by Kodak has an upper lens being a fixed focal lens and a lower lens being a 3× optical zoom lens; thus it is capable of tele-shooting and shooting in macro shooting mode, so as to make up for the defects of the fixed focal lens. In another embodiment disclosed in the present invention, if capable of being embodied with, the inventive method is different from the V570 dual lens camera. The optical module of the present invention is externally connected to the image capture apparatus (the signal processing module 200 and the second optical module 210), and with the signal switching of the switching module, the optical modules of different specifications are replaced to become the lens component of the image capture apparatus, which is not limited to the fixed focal lens or the zoom lens, instead, the optical specifications required for the user can be changed.

In summary, it is fully revealed that both the object and the effect of the image capture device of the present invention are quite advanced for being practiced, and the present invention is of great value in industrial usage and is a novel invention never found in the current market, fully conforming to the requirements for a patent, therefore, it is applied according to the law.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An image capture device, used for capturing an image and storing as digital data comprising:
a first optical module, used for capturing the image and transferring to an first image data; and
a signal processing module, detachable disposed on the first optical module, the signal processing module receiving and processing the first image data and storing it as the digital data.

2. The image capture device according to claim 1, wherein the first optical module has a second connecting element, the signal module has a first connecting element, the first connecting element is detachable electrically connected to the second element for the signal processing module to receive the first image data.

3. The image capture device according to claim 1, wherein the signal processing module further comprises a shutter button, when the shutter button is pressed, the signal processing module sends a capture command to the first optical module to start capturing the image.

4. The image capture device according to claim 1, wherein the image capture device further comprises a snap structure jointing the signal processing module and the first optical module with each other.

5. The image capture device according to claim 4, wherein the snap structure comprises at least one hook disposed on the first optical module, and at least one slot disposed the signal processing module, and the hook clips the slot.

6. The image capture device according to claim 1, wherein the first optical module has a lens and a sensing element to capture the image and transfer into the image data.

7. The image capture device according to claim 6, wherein the sensing element is a charge coupled device (CCD).

8. The image capture device according to claim 1, wherein the signal processing module further comprises:
a second optical module, built in the signal processing module and capturing the image and transfer to a second image data; and
a switching module, selectively switching the first image data or the second image data to the signal processing module to be received, processed and stored it as the digital data.

9. The image capture device according to claim 8, wherein the signal processing module further comprises a shutter button, when the shutter button is pressed, the signal processing module sends a capture command switched by the switching module to either the first optical module or the second optical module to start capturing the image.

10. The image capture device according to claim 8, wherein the image capture device further comprises a snap structure jointing the signal processing module and the first optical module with each other.

11. The image capture device according to claim 10, wherein the snap structure comprises at least one hook disposed on the first optical module, and at least one slot disposed the signal processing module, and the hook clips the slot.

12. The image capture device according to claim 8, wherein the first optical module has a lens and a sensing element to capture the image and transfer into the first image data.

13. The image capture device according to claim 12, wherein the sensing element is a charge coupled device (CCD).

14. The image capture device according to claim 8, wherein the second optical module has a lens and a sensing element to capture the image and transfer into the second image data.

15. The image capture device according to claim 14, wherein the sensing element is a charge coupled device (CCD).
